(19) United States
(12) Patent Application Publication
(10) Pub. No.: US 2004/0049785 A1
(43) Pub. Date: Mar. 11, 2004

(54) Method and apparatus for delivering personalized alerts to set top box users without user intervention

(75) Inventors: Richard Stephen Grzeczkowski, Warrington, PA (US); David E. Zeidler, Warrington, PA (US); Matthias Anton Muller, Line Lexington, PA (US)

Correspondence Address: MAYER, FORTKORT & WILLIAMS, PC, 251 NORTH AVENUE WEST, 2ND FLOOR, WESTFIELD, NJ, 07090, US

(73) Assignee: General Instrument Corporation

(21) Appl. No.: 10/236,664

(22) Filed: Sep. 6, 2002

(51) Int. Cl. H04N 7/025; H04N 7/10; G06F 3/00; H04N 5/445; G06F 13/00; H04N 7/173

(52) U.S. Cl. 725/46; 725/35; 725/33; 725/34

(57) ABSTRACT

An Alert/Warning Interface resides in a set top box, which is coupled to a user's television, and an Information Server located in the cable plant origination center or head-end. The end user of the set top box is able to configure a profile that includes weather areas to be monitored, roads traveled, and schools their children attend. This profile is stored on the Information Server, along with the profiles of all other users. The Information Server monitors for alert conditions, such as bad weather, traffic jams, and school closings. If any of these events occurs, a message is sent to the set top box associated with a profile indicating the current error condition. Upon receipt of an Alert message, the set top box places an icon (or other graphic) in a predetermined portion of the screen (e.g., a top/bottom corner) indicating an alert has occurred. The user can then switch to the Alert screen view, at which time the Alert icon turns off.

### STATEMENT OF RELATED APPLICATION

This application is related to co-pending U.S. patent application Ser. NO. ______ [Attorney Docket D2807], entitled “Method and Apparatus For Scrolling Television Programming Data On Screen During Program Viewing,” filed on even date herewith.

### FIELD OF THE INVENTION

The present invention is directed to methods and apparatuses for interacting with a television viewer, and more particularly to a method and apparatus for interacting with a television viewer via a set top box to provide personalized information to the viewer, such as traffic, school, organization and weather alerts, without intervention by the viewer.

### BACKGROUND

Many techniques exist for broadcasting information to individuals alerting them to emergency situations, such as weather emergencies, school and organization closings, imminent attacks, etc. Other techniques exist for providing computer users personalized information, e.g., Pointcast, which is an information source that downloads prescreened information to a user's computer on a regular basis based on a user's screening selections.

Yet many people are not computer users, and some computer users are not online for significant periods.

The present invention is therefore directed to the problem of developing a method and apparatus for providing user selectable information to television viewers on a regular basis.

### SUMMARY OF THE INVENTION

The present invention solves these and other problems by providing inter alia a method and apparatus for providing user selectable information via a user's set top box that is coupled to the user's television.

According to one aspect of the present invention, an exemplary embodiment of a method for providing user selectable information to a user via a set top box includes storing a user profile regarding one or more user specifiable alerts desired to be sent to the user upon an occurrence of one of the user specifiable alerts, sending an alert message to a set top box associated with the user that one of the user specifiable alerts has occurred, and indicating on a display coupled to the set top box receipt of this alert message.

According to another aspect of the present invention, an exemplary embodiment of a method for providing user selectable information to a user via a set top box includes receiving a user profile including one or more information alerts to be monitored for the user, storing the user profile, comparing the user profile against a database of information alerts, and sending one or more information alerts from the database that match the one or more user information alerts.

According to still another aspect of the present invention, an exemplary embodiment of a method for providing user selectable information to a user via a set top box includes using a graphical user interface to obtain user preferences regarding one or more personal information alerts to be monitored for the user, storing the user profile in the set top box, triggering a personal information alert update based on a user command, and requesting matching alerts from a server.

According to yet another aspect of the present invention, an exemplary embodiment of an apparatus for providing user selectable information to a user includes a set top box, a server and a database. The set top box receives a user profile including one or more information alerts to be monitored for the user and stores the user profile. The server is coupled to the set top box and receives the user profile. The database is coupled to the server and stores a plurality of information alerts. The server compares the user profile against the database of information alerts, and sends to the set top box one or more information alerts from the database that match the one or more user information alerts.

### BRIEF DESCRIPTION OF THE DRAWINGS

FIG. 1 depicts a block diagram of an exemplary embodiment of an apparatus for providing user selectable information to the user via a cable television set top box according to one aspect of the present invention.

FIG. 2 depicts a block diagram of a flow chart of an exemplary embodiment of a method for providing user selectable information to the user via a cable television set top box, in which a user profile is stored in a central server of the cable plant and personalized alerts are pushed down to the user, according to another aspect of the present invention.

FIG. 3 depicts a block diagram of a flow chart of a second exemplary embodiment of a method for providing user selectable information to the user via a cable television set top box, in which a user profile is stored in the user's set top box and personalized alerts are pulled down from a server, according to yet another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

According to an exemplary embodiment of the present invention, an Alert/Warning Interface would reside on a set top box, which is coupled to a user's television, and an Information Server located in the cable plant origination center or head-end. The end user of the set top box is able to configure a profile that would include weather areas to be monitored, roads traveled, and schools and organizations they or their children attend. This profile would be stored on the Information Server, along with the profiles of all other users. The Information Server would then monitor for alert conditions, such as bad weather, traffic jams, and school and organization closings. If any of these events were to occur, a message would be sent to the set top box associated with a profile indicating the current alert condition. Upon receipt of an Alert message, the set top box would place an icon (or other graphic) in a predetermined portion of the screen (e.g., a top/bottom corner) indicating an alert had occurred. The user would then switch to the Alert screen view, at which time the Alert icon would switch off. The Alert screen view would provide details of the particular alert.

Currently, alerts for certain factors can be passed to cell phones, beepers, and email. Doing so in the manner provided herein, however, provides an alert to the widest possible individuals, as televisions are more widely monitored than the above devices. Many people turn their televisions on in the morning to try to obtain some of the news the alert mechanism would provide. This alert mechanism would provide peace of mind to individuals that the roads they plan to travel that morning are no more congested that usual, that their children's schools remain open, and that there is no major weather affecting their region. The monitoring is completed without any intervention from the user. Moreover, in most cases lack of the alert symbol quickly indicates to a user that the status quo is in effect. Thus, a user simply needs to check for the alert icon to determine if any unusual situations exist that might require new planning.

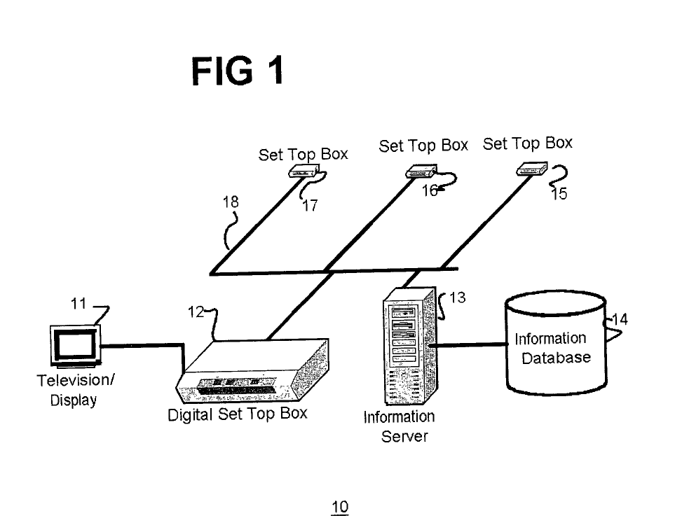

Turning to FIG. 1, shown therein is an exemplary embodiment of an apparatus 10 for providing personalized alerts to a user of a set top box 12. In this case, the user's set top box 12 is coupled to a cable plant 18; however, another type of communications system could be employed, such as a satellite communications system. Other users are simultaneously coupled to the cable plant 12 via their set top boxes 15, 16, 17.

An exemplary embodiment of a set top box is Motorola's DCT2000 and subsequent versions. This set top box is capable of interacting with the user by displaying an electronic programming guide, a page of which could display alert information. In addition, this set top box is capable of displaying menu items and displaying subsequent menus when selected by a user. Moreover, this set top box is capable of receiving user selections of listed items and storing them in a memory. These features can be used to display alert information categories, subcategories for each alert category and list of potential personalized alerts from which the user can select.

Each set top box has a television or monitor, such as television/display 11, coupled to it. Set top box generated information can be viewed on this television or monitor. Additionally, more advanced set-tops, such as the Motorola DCT5100 could convey the alert information to the user by way of audio in addition to visual display to the television or monitor.

The set top box includes a processor (not shown) that interacts with the user via the display 11 to obtain the user profile, which is used to query the database 14 as will be discussed below. The processor, the display, a remote control, or keyboard and related programming constitute a graphical user interface via which a user can select from several possible alert types and also enter specific information regarding each alert type, such as a school name for alerts related to schools. Alternatively, the user can select a particular school from a list of schools presented via the graphical user interface.

Each alert type when selected may have additional menus that enable the user to personalize the alert type by selecting a subset of alerts related to each alert type. For example, if the user selects the alert type “financial alerts”, the user is then presented a screen of possible financial instruments or categories from which the user can select. For example, if the user selects “stocks,” the user is presented with a list of stocks from which he can select, or alternatively the user can input a stock symbol, or search for a stock symbol by entering a company name.

On the weather category, the user can select a particular city or cities about which the user is desirous of obtaining alert information. For example, by selecting weather, the user is then presented with a list of cities or regions, from which the user can select about which to received weather alerts. If a particular region is not displayed, the user can enter other meta data about the region to obtain related information, such as longitude and latitude or other similar information that can be used to identify a location around which to monitor for weather information.

On a traffic category, the user is presented with a list of cities, and then known traffic corridors in that city, from among which the user can select one or more. Alternatively, the user can input a list of roads that can be used as key words in a search of traffic reports.

An information server 13, to which is coupled an information database 14, is also coupled to the cable plant 12. The information server 13 is a standard internet type server that provides Internet Protocol communications between a standard communications processor located in the set top box 12, via which communications the information server 13 provides personalized alerts to each user that match the user profile submitted by each user.

The database 14 is a standard database that can be queried with a user's profile and output entries in the database 14 that match the query. The database entries include alert information collected on all schools, organizations, traffic, weather in all regions, stock, bonds, mutual funds, and other similar information, as discussed herein. Upon activation of a routine to determine if a given user's profile matches any entries in the database 14, the database 14 searches these entries for each entry in the user's profile to determine if a match exists. If so, any information related to that entry is uploaded to the server 13, formatted in an alert message to the user and transmitted to the user's set top box 12, 15-17 over the cable plant 18.

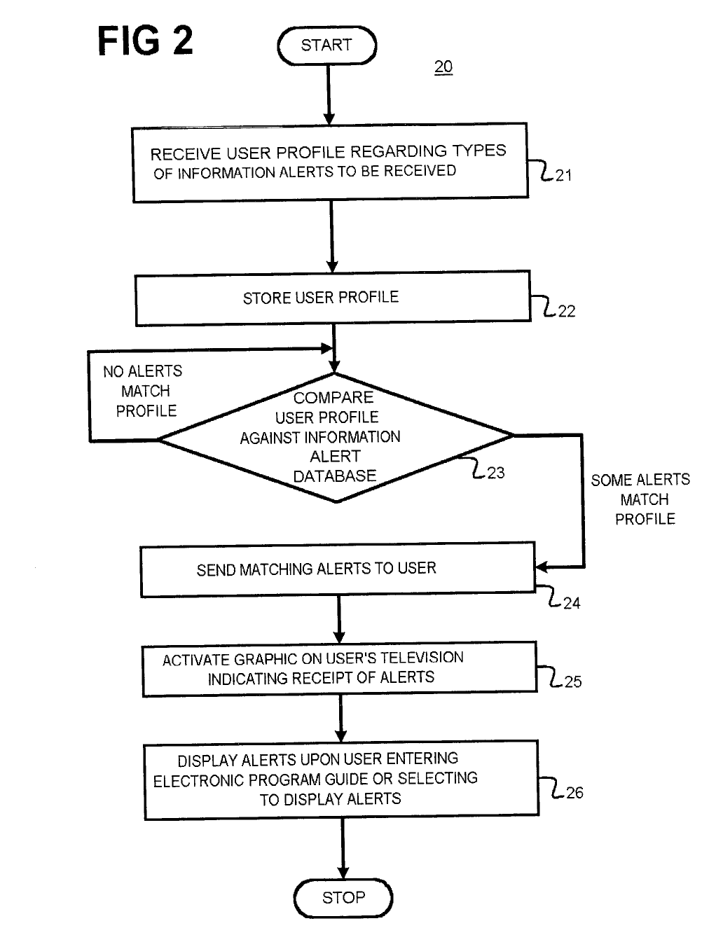

Turning to FIG. 2, shown therein is an exemplary embodiment of a method 20 for providing personalized alerts to a user who has a set top box to which is coupled a communications system, such as a cable plant. In this embodiment, the personalized alerts are pushed down to the user based on a user profile stored in a central server or servers.

First, the central server receives the user profile that the user prepared while interacting with the set top box (element 21). This user profile is then stored in this central server or servers (element 22). The server then compares or queries a database that stores all of the alerts for all users (element 23). If the server identifies a match between a stored alert and the user's profile, then the server sends the matching alerts to the user's set top box (element 24). Upon receipt of the alerts, a graphic or icon is displayed on a monitor or display (e.g., a television) coupled to the set top box (element 25). When the user enters the menu for displaying the alerts, the received alerts are then displayed and the graphic is removed from the display (element 26). This menu could be a predetermined page of an electronic programming guide. The process then ends. If no matches are identified in step 23, the process either ends or continues monitoring for new matches.

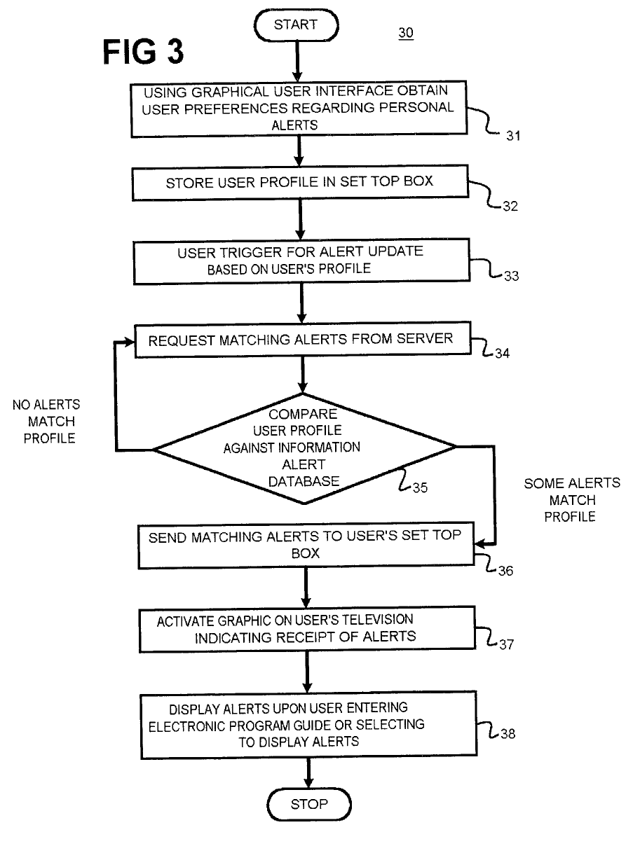

Turning to FIG. 3, shown therein is another exemplary embodiment of a method 30 for providing personalized alerts to a user who has a set top box to which is coupled a communications system, such as a cable plant. In this embodiment, the personalized alerts are pulled down by the user from the server user based on a user profile stored in the user's set top box.

First, using a graphical user interface the user creates his or her user profile (element 31). The set top box then stores the user profile that the user prepared (element 32). At predetermined times and/or by user trigger (element 33), the set top box uploads the user profile, or portions thereof as selected by the user, to the server (element 34) requesting matches to the user's profile. The server then compares or queries a database that stores all of the alerts for all users (element 35). If the server identifies a match between a stored alert and the user's profile, then the server sends the matching alerts to the user's set top box (element 36). Upon receipt of the alerts, a graphic or icon is displayed on a monitor or display (e.g., a television) coupled to the set top box (element 37). When the user enters the menu for displaying the alerts, the received alerts are then displayed and the graphic is removed from the display (element 38). As in the above process 20 of FIG. 2, this menu could be a predetermined page of an electronic programming guide. The process 30 then ends. If no matches are identified in step 35, the process either ends or continues monitoring for new matches.

Although various embodiments are specifically illustrated and described herein, it will be appreciated that modifications and variations of the invention are covered by the above teachings and are within the purview of the appended claims without departing from the spirit and intended scope of the invention. For example, the user alert information could be transmitted over any type of communications system to a set top box, such as a telephone or satellite. The communication channel between the user's set top and information server can be type supported by the particular set-top box including but not limited to in-band data delivery, out-of-band data delivery, telephone return, DOCSIS bi-directional, and RF return. Furthermore, these examples should not be interpreted to limit the modifications and variations of the invention covered by the claims but are merely illustrative of possible variations.

What is claimed is:

1. A method for providing user selectable information to a user via a set top box comprising:
storing a user profile regarding one or more user specifiable alerts desired to be sent to the user upon an occurrence of said one or more user specifiable alerts;
sending an alert message to a set top box associated with the user that one or more of said one or more user specifiable alerts have occurred; and
indicating on a display coupled to the set top box receipt of said alert message.

2. The method according to claim 1, further comprising downloading information regarding said one or more of said one or more user specifiable alerts that have occurred to the set top box associated with said user.

3. The method according to claim 2, further comprising displaying said information regarding said one or more of said one or more user specifiable alerts that have occurred on the display associated with the set top box.

4. The method according to claim 3, wherein displaying said information regarding said one or more of said one or more user specifiable alerts that have occurred includes placing said information on a predetermined page of an electronic program guide that can be opened by a user interacting with the user's set top box.

5. The method according to claim 1, wherein said user profile is stored on one or more servers in a communication system.

6. The method according to claim 1, wherein said user profile is stored in the set top box associated with said user.

7. The method according to claim 6, wherein the user profile, or portions thereof as selected by the user, is transmitted to one or more information servers on a predetermined basis and/or by user trigger, to determine if any alerts stored in the one or more information servers match the one or more user specifiable alerts.

8. The method according to claim 7, wherein upon determining that one or more alerts exist that match one or more of the user specifiable alerts downloading information related to said one or more matching alerts.

9. The method according to claim 1, wherein said one or more user specifiable alerts include traffic information related to one or more user specifiable travel routes.

10. The method according to claim 1, wherein said one or more user specifiable alerts include school and organization closing information related to one or more user specifiable schools and organizations.

11. The method according to claim 1, wherein said one or more user specifiable alerts include local weather information.

12. The method according to claim 1, wherein said one or more user specifiable alerts include weather information related to a user specifiable region.

13. The method according to claim 1, wherein said one or more user specifiable alerts include airplane schedule information related to one or more user specifiable flights.

14. The method according to claim 1, wherein said one or more user specifiable alerts include mass transit schedule information related to one or more user specifiable mass transit identifiers.

15. A method for providing user selectable information to a user via a set top box comprising:
receiving a user profile including one or more information alerts to be monitored for the user;
storing the user profile;
comparing the user profile against a database of information alerts; and
sending one or more information alerts from the database that match the one or more user information alerts.

16. The method according to claim 15, further comprising activating a graphic on a display coupled to the set top box of the user upon receipt of the one or more matching information alerts.

17. The method according to claim 16, further comprising displaying the one or more received alerts upon user command.

18. A method for providing user selectable information to a user via a set top box comprising:
using a graphical user interface to obtain user preferences regarding one or more personal information alerts to be monitored for the user;
storing the user profile in the set top box;
triggering a personal information alert update based on a user command;
requesting matching alerts from a server.

19. The method according to claim 18, further comprising comparing the one or more personal information alerts of the user against a database of information alerts.

20. The method according to claim 19, further comprising sending one or more information alerts from the database that match the one or more personal information alerts of the user.

21. The method according to claim 18, further comprising activating a graphic on a display coupled to the set top box of the user upon receipt of one or more matching information alerts.

22. The method according to claim 21, further comprising displaying the one or more received alerts upon user command.

23. An apparatus for providing user selectable information to a user comprising:
a set top box receiving a user profile including one or more information alerts to be monitored for the user and storing the user profile;
a server coupled to the set top box and receiving the user profile; and
a database coupled to the server and storing a plurality of information alerts, said server comparing the user profile against the database of information alerts, and said server sending to the set top box one or more information alerts from the database that match the one or more user information alerts.

24. The apparatus according to claim 23, further comprising a display coupled to the set top box, wherein the set top box activates a graphic on the display upon receipt of the one or more matching information alerts from the server.

25. The apparatus according to claim 24, wherein the display displays the one or more received alerts upon user command.
